(19) United States
(12) Patent Application Publication
(10) Pub. No.: US 2008/0109895 A1
(43) Pub. Date: May 8, 2008

(54) Method and System for Multi-Authentication Logon Control

(75) Inventor: Angel Janevski, New York, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,415

(22) PCT Filed: Aug. 5, 2005
(86) PCT No.: PCT/IB05/52617

§ 371 Date: Feb. 8, 2007

Related U.S. Application Data
(60) Provisional application No. 60/600,258, filed on Aug. 10, 2004.

(51) Int. Cl. G06F 21/00

(52) U.S. Cl. 726/19

(57) ABSTRACT

A method and system for multi-authentication log-on control are provided. The method and system include two authentication mechanisms. The first one is a device that provides a physical key, and the other one is a proximity device, which identifies a user when in the proximity of a reader. These devices allow the user to log in to a computer system (100) effortlessly just by touching a reader with the physical key, and the user will be automatically logged off when they step away from the computer. A method includes the steps of verifying the user physically at the at least one terminal (340, 342); granting access to the at least one terminal if the user is verified (344); detecting the user within a predetermined distance of the at least one terminal (360); and logging off the user when the user is outside the predetermined distance (366).

The present disclosure relates generally to data processing and communication systems, and more particularly, to a method and system for multi-authentication log-on control.

In many computer applications, it is the case that more than one user utilizes a single device, e.g., a workstation, server, etc. In particular, a single device is used by the users through some kind of authentication process (e.g., part of the log-in), after which the user is allowed to perform some operations. These sessions can either overlap (i.e., multiple uses by multiple users in a given time slot) or be subsequent (i.e., single user in a given time slot).

Such-multi user environments are a cause for several problems, which range from convenience (e.g., complicated log-in) to proper identification (e.g., using the computer system on the previously logged-in account), and data security (gaining access to data using the previously logged-in user that has not logged out). Numerous solutions exist that address some of the issues above. For example, to overcome security level and log-in inconvenience, a number of devices exist to authenticate users. Some of these technologies include biometric readers (e.g. fingerprint readers), secure tokens, smartcards, and proximity readers (e.g., RF tags).

Support functions in the context of user authentication address additional technical controls in combination with authentication technologies. Such controls enhance security by enforcing authentication of a user in certain situations, typically related to long system idle times, long system use times, or any other criteria that may suggest authentication or re-authentication. Usually these functions address the problem that authentication is done once to obtain access to a system and afterwards the assumption is that the user who was authenticated is still using the system after a certain period of time. In fact, it is common practice in clinical environments to share one common account among several users for convenience purposes.

To lower the possibility of account misuse, a number of mechanisms exist such as automatic user log out on timeout, password-protected screensavers, and smartcards that keep the users logged-in as long as the card is inserted in a smartcard reader.

Time outs are the most common countermeasure to ‘open session re-use’, be it by legitimate users or intruders. The basic concept is to periodically: (1) perform checks if a system is still being used a certain time after authorization; and (2) require renewal user authentication. These concepts lend themselves to what is known as dead man switch in other industries, such as railways and freight elevators, intended to take some action if a human operator becomes incapacitated in some way. The main problem is the trade off between security and user comfort. Short time out periods provide reasonable protection against friendly or unfriendly session take-over but require users to authenticate more often. Typical time out periods in clinical environments are 5 to 30 minutes.

Session lock after period of inactivity is a widely implemented technical control of operating systems or application systems that locks a running session after a period of inactivity. Inactivity is usually determined by sensing keystrokes and mouse activities. Once a session is locked, it can only be unlocked by the owner of the running session or a system administrator. This concept works well for work spots that are mainly used by one user. This concept is not acceptable for shared work spots because a locked session prevents any other user from using the system unless the owner of the session unlocks it.

Session and/or application termination after period of inactivity is an alternative to session locking. This concept shuts down a session or an application after a period of inactivity. Once this has been done, the system can be used by other users after authentication. If OS (Operating System) sessions and/or application systems need considerable time to start up, this may have a negative impact on user comfort and productivity.

Periodic authentication request is similar to dead man switches as observed in other industries. Regardless of any session activity since a user has been authenticated, he or she must periodically re-authenticate to keep a session alive. Ignoring this re-authentication request causes a session to terminate. If OS sessions and/or application systems need considerable time to start up, again this may have a negative impact on user comfort and productivity.

Knowing about the shortcomings of time out based security controls, the industry has tried to come up with alternative solutions to solve the problem of open sessions and their possible misuse. Among the more mature technologies is proximity detection based on active badges using RF (radio frequency) techniques. This concept uses the limited range of RF waves in conjunction with a transmitted unique badge IDs to detect if a user is within a certain range of a work spot. There are two possible ways of utilizing this technology: (1) automatic authentication when a user approaches a work spot; and (2) detection of users walk-away from a work station and subsequent automatic session/application termination. However, in confined clinical locations, the system may detect more than one user within the specified range. This problem is hard to solve since the range of RF waves can only be roughly adjusted typically from 10 to 20 feet and may change unpredictably according to environmental changes.

With healthcare providers relying more and more on electronic access to patient data systems, their accessibility is becoming vital. Vendors of IT for clinical application must ensure high system up times and reliable data storage and retrieval. Therefore, systems have built-in technical redundancies to provide access to data almost anytime. User authentication must not be a new barrier between these data and a clinical user. For this reason, most advanced authentication methods provide user ID/password based authentication for emergency access or back-up as required HIPAA § 164.312 Technical safeguards (2)(ii). The problem with these back-up authentication methods is sometimes they become the preferred way to get access to a system because they are often more convenient from a user's point of view. This can only be avoided by making access using the main authentication method more attractive than the back-up method. This can be achieved by a combination of technology and policy, for example, encouraging users to use the default authentication by making it convenient, if possible more convenient than the back-up method; and discouraging the use of the back-up method by monitoring its use and enforcement of audits with the users on the use of the back-up method. The former must be part of the technical concept of a system while the latter must be backed by a policy, implemented by clinical sites as part of their global security policy.

Therefore, a need exists for techniques to allow users to easily and conveniently access computer systems and their data. Furthermore, a need exists for authentication techniques which overcome the above-described drawbacks.

A method and system for multi-authentication log-on control are provided. The method and system of the present disclosure overcome the problems of loosely defined start and end of user sessions on multi-user computer systems. The application of user authentication with a usage of a strict behavioral protocol ensures convenient log-in and automatic log-out. This is particularly useful in an environment where more than one authorized user is in the proximity of a computer system. The method and system include two authentication mechanisms. The first one is a device that provides a physical key, and the other one is a proximity device, which identifies a user when in the proximity of a reader. These devices allow the user to log in effortlessly just by touching a reader with the physical key, and the user will be automatically logged off when they step away from the computer.

In one aspect of the present disclosure, a method for authenticating a user in a computer system including at least one terminal is provided, the method including the steps of verifying the user physically at the at least one terminal; granting access to the at least one terminal if the user is verified; detecting the user within a predetermined distance of the at least one terminal; and logging off the user when the user is outside the predetermined distance.

In another aspect, a system for authenticating a user in a computer system including at least one terminal is provided. The system including a proximity identification reader for detecting a user within a predetermined distance of the at least one terminal; a physical identification reader for verifying the user physically at the at least one terminal; and a processor for granting access to the at least one terminal if the detected user is verified.

In a further aspect, a program storage device readable by a machine, tangibly embodying a program of instructions executable by the machine to perform method steps for authenticating a user is provided, the method steps including verifying the user physically at the at least one terminal; granting access to the at least one terminal if the user is verified; detecting the user within a predetermined distance of the at least one terminal; and logging off the user when the user is outside the predetermined distance.

The above and other aspects, features, and advantages of the present disclosure will become more apparent in light of the following detailed description when taken in conjunction with the accompanying drawings in which:

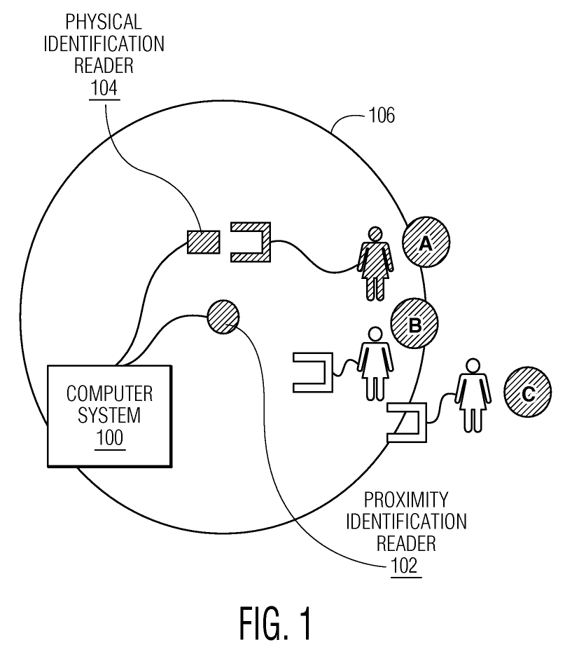

FIG. 1 is a block diagram of an exemplary system for authenticating a user of a computing system in accordance with an embodiment of the present disclosure;

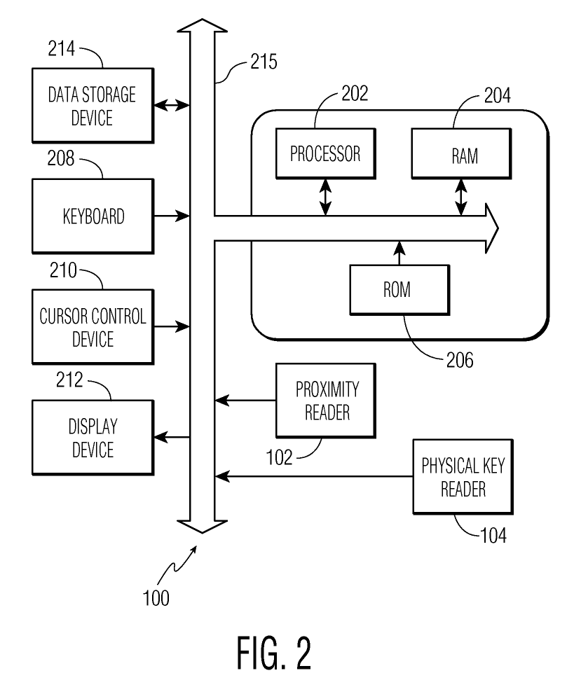

FIG. 2 is an exemplary computer for use in the system shown in FIG. 1;

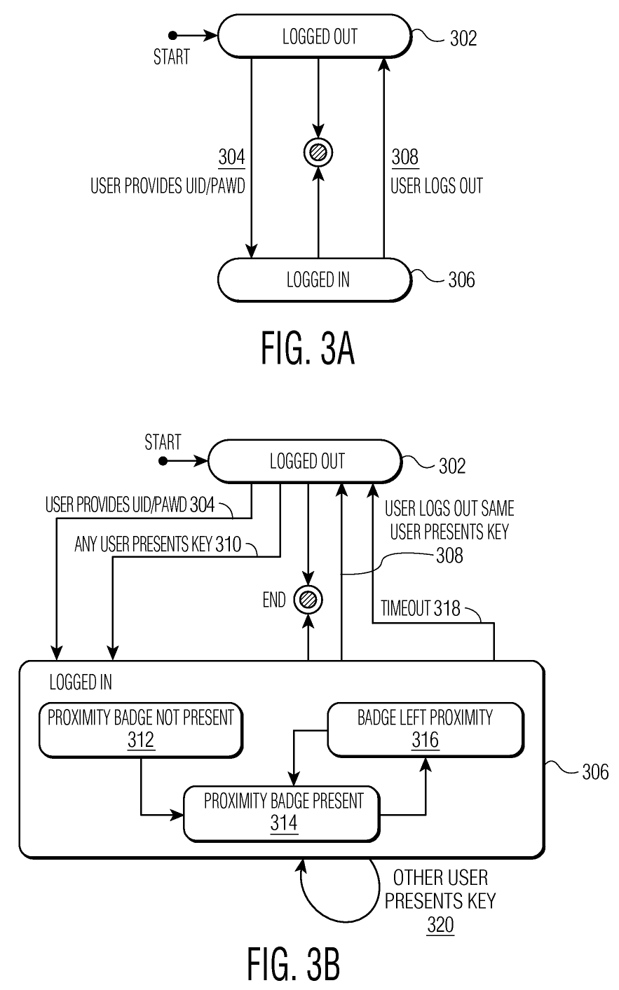

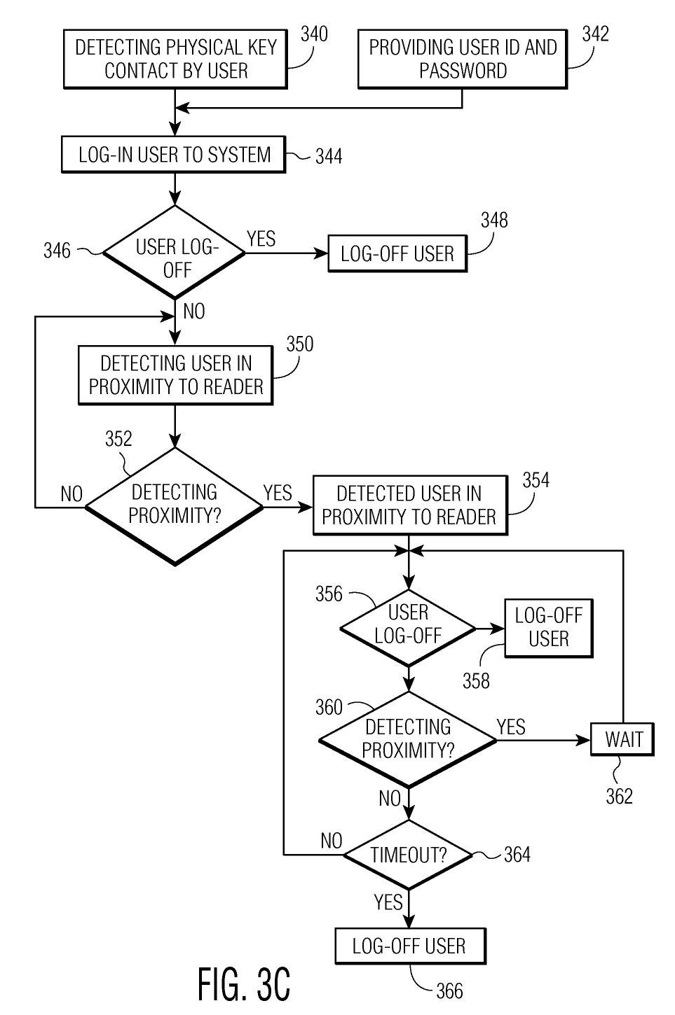

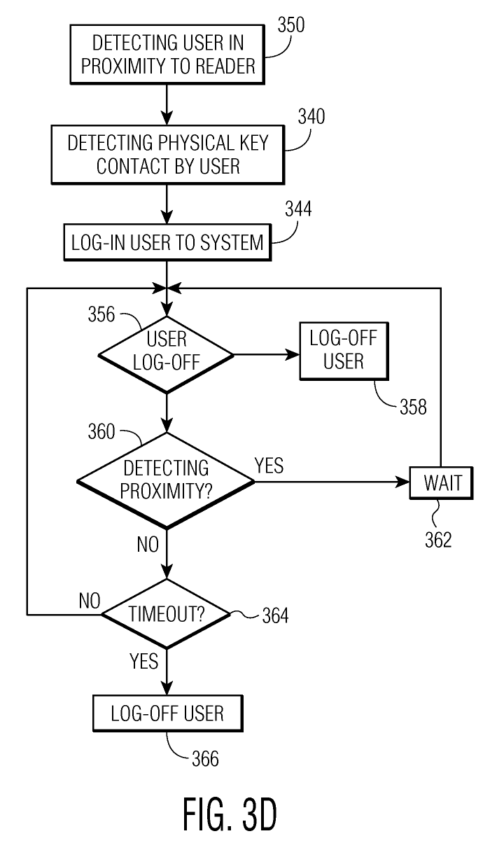

FIG. 3A is a state diagram of a conventional authentication scheme;

FIG. 3B is a state diagram of an authentication mechanism according to the present disclosure;

FIG. 3C is a flowchart illustrating a method for authenticating a user in accordance with an embodiment of the present disclosure;

FIG. 3D is a flowchart illustrating a method for authenticating a user in accordance with an embodiment of the present disclosure;

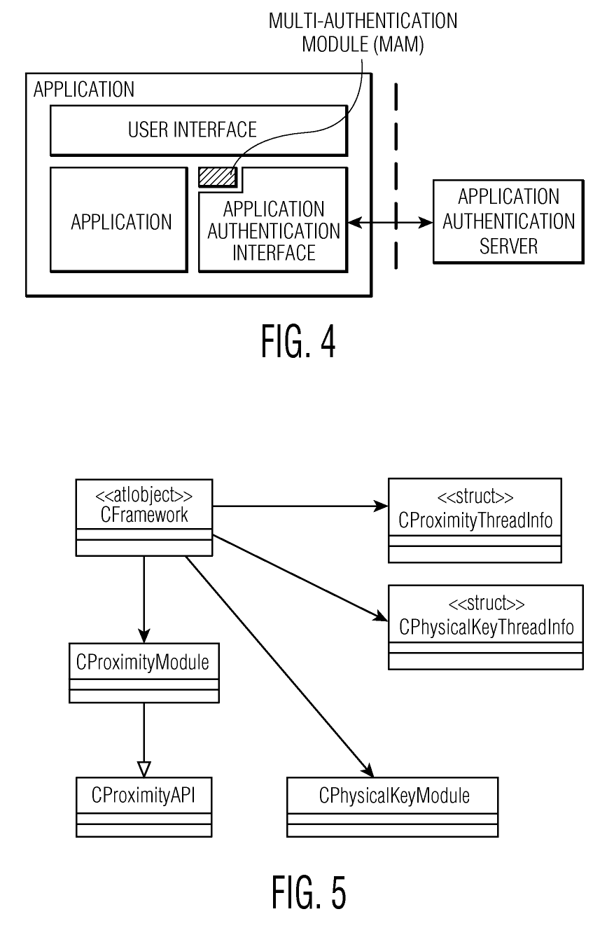

FIG. 4 is a block diagram illustrating the interaction of the authentication method with other modules and components of the computer system;

FIG. 5 is an authentication framework class diagram in accordance with the present disclosure;

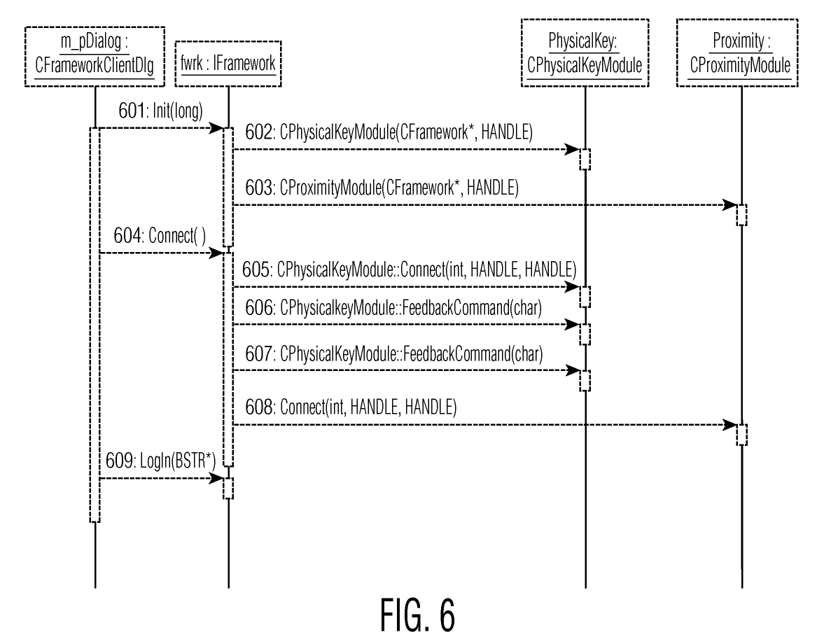

FIG. 6 is a sequence diagram for initializing the authentication framework;

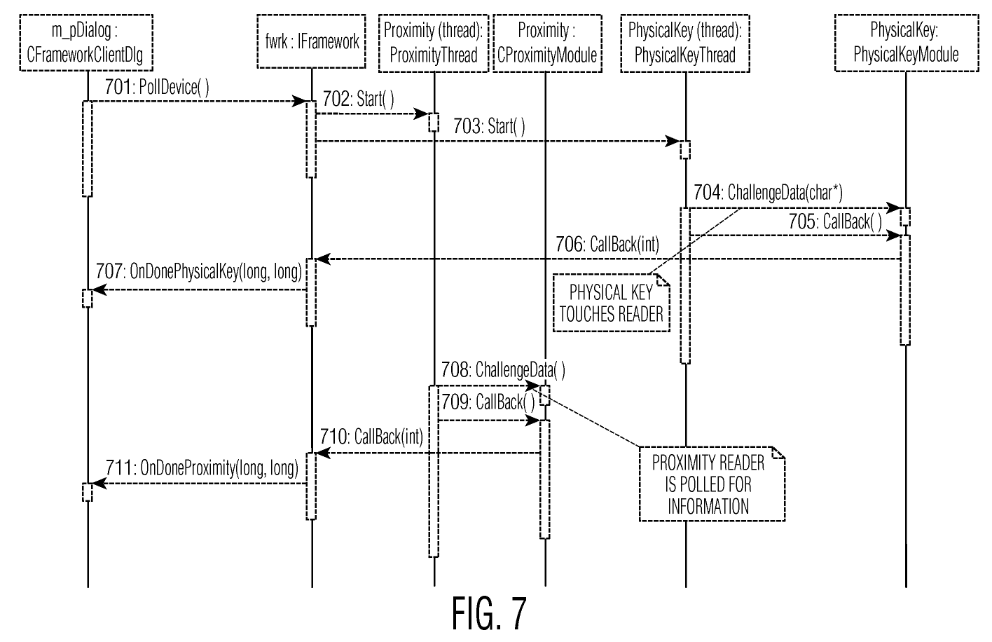

FIG. 7 is a sequence diagram for putting the authentication framework in a poll mode; and

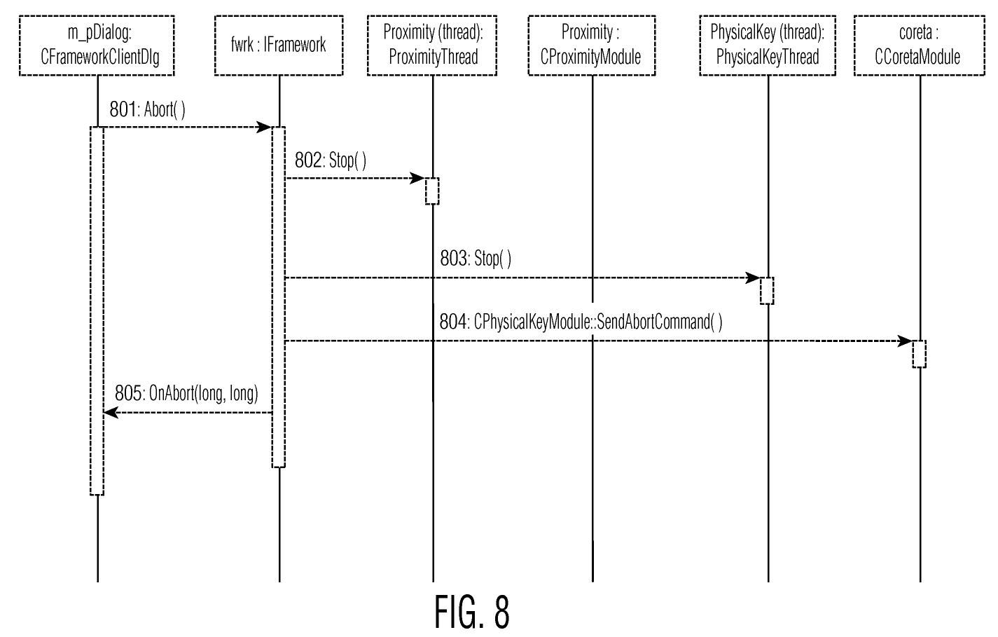

FIG. 8 is a sequence diagram for aborting the poll mode.

Preferred embodiments of the present disclosure will be described hereinbelow with reference to the accompanying drawings. In the following description, well-known functions or constructions are not described in detail to avoid obscuring the present disclosure in unnecessary detail.

A system and method for authenticating a user according to the present disclosure enables controlled but convenient access to computer systems. Referring to FIG. 1, an embodiment of the disclosure includes a combination of two authentication modes or mechanisms for use in a computer system 100. The computer system 100 includes two identification devices: a proximity identification reader 102 and a physical identification reader 104. The proximity identification reader 102 can provide the identification of a person (via a tag) in the proximity of the reader 102. Such devices can operate on a variety of proximity ranges, but in clinical setting, 2 m would be a reasonable active proximity radius 106. In addition to the tag that is detected by the proximity reader 102, the user will have one more tag (or can use the same tag) in a physical identification reader 104 where the identification is achieved by explicit contact between the tag and the reader (e.g. physical contact).

In the embodiment shown in FIG. 1, the criteria for logging-in a user is that (1) the proximity reader 102 has registered the user in its proximity 106, and (2) the user explicitly authenticated himself with the explicit contact reader 104. The user is logged-out of the application as soon as they leave the proximity of the device 106. Other users of the device can log-in by identifying himself with the explicit identification device 104. For example, users A and B are in the proximity radius 106 of the system, but user A is logged in because they identified himself with the physical identification device 104. User B can log-in by making a contact with its identification tag and the reader 102. Since user C is outside the proximity radius 106 of the proximity identification reader 102, user C is not registered at all in the computer 100.

It is to be understood that the present invention may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine 100 comprising any suitable architecture such as a personal computer, a workstation or server. Referring to FIG. 2, preferably, the machine 100 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. A system bus 215 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform by various interfaces and bus structures, such a parallel port, serial port or universal serial bus (USB). The peripheral devices may include a proximity reader 102, physical key reader 104, additional storage devices and a printer.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure. The authentication method of the present disclosure may be used at several levels, including operating system, application, or application components.

The computer 100 may operate in a networked environment using logical connections to one or more remote computers. The remote computer may be a personal computer, a server, a router, a network PC, a peer device or other common network node, and typically includes many or all of the elements described above relative to the computer 100. It is to be appreciated that the network may be a local area network (LAN), wide area network (WAN), the Internet or any known network that couples a plurality of computers to enable various modes of communication via network messages. For example, the system may be a corporate intranet including a single server and multiple personal computers housed within a single facility, or alternatively, multiple servers with multiple personal computers located in various geographic locations.

The proximity identification reader 102 may be any known device which wirelessly communicates to an identification tag, for example, by radio frequency (RF) waves, Bluetooth™, the 802.11 standard, etc. An exemplary reader and tag may communication via RFID (radio frequency identification) technology such as the I-CODE™ reader and label commercially available from Philips Semiconductor of Eindhoven, The Netherlands, the assignee of the present application. Further exemplary proximity readers and tags include the eProx™ reader and tag system commercially available from HID Corporation of Irvine, Calif., and the AIR ID reader and badge system commercially available from RFIDeas, Inc. of Arlington Heights, Ill.

The physical identification reader 104 may be a biometric reader such as a fingerprint reader, hand geometry reader, facial recognition reader or iris recognition reader. One such exemplary fingerprint reader is the BioTouch™ fingerprint reader commercially available from Identix Incorporated of Minnetonka, Minn. It is to be appreciated that when using a biometric reader as the physical identification reader the user is not required to present a physical key to the system but only the appropriate body part, thereby simplifying use of the system and eliminating the burden of carrying, and remembering, an additional identification device for the user.

Alternatively, the physical identification reader may be a contact reader used in conjunction with a secure token. An exemplary contact reader is commercially available from Coreta™ GmbH of Dresden, Germany. The Coreta™ reader is used in conjunction with a ring key, e.g., a passive token, which communicates to the reader when in contact with the reader to provide the identity of the ring key holder. Furthermore, a smartcard and associated reader may be employed for physical identification. The smartcard/reader combination may be either a contact or contactless system as are known in the art.

It is to be appreciated that the proximity tag and physical key tag could be merged in a single, integrated tag, and likewise, a single, integrated reader implementation could be employed. For example, the tag may include an embedded antenna for wireless communication during proximity detection and contact terminals for physically contacting a reader during physical identification. Likewise, the reader would have similar wireless components and means for reading information from the tag when in physical contact, e.g., a swipe reader, insertion reader, etc, as are known in the art.

Operation of the above described system will now be described. To illustrate the advantages of the system and method of the present disclosure, a state diagram of a conventional log-in or authentication scheme is illustrated in FIG. 3A. The conventional scheme only supports explicit user logins where users provide a combination of a user ID and a password 304 to obtain access to the application, e.g., a logged in state 306. Once a user is logged in, the user remains logged in until logout is invoked by a click on a button 308, and the user subsequently enters a logged out state 302. If the same user or any other user needs to log in, they will have to click on a login button that will provide them with the login dialog.

Referring to FIG. 3B, a state diagram of an authentication mechanism according to the present disclosure is shown. The conventional login mechanism is extended with two mechanisms in addition to the user id/password (e.g., uid/pwd) authentication shown in FIG. 3A. The user can present a physical key 310, which replaces the uid/pwd pair 304, to login, logout (if already logged in), or logout another user and login themselves (if another user is already logged in). In addition, the second mechanism keeps track of proximity badges or tags that are in the vicinity of the computer 100 when the user is in the logged in state 306. When the user is in the logged in state 306, it will be determined if a badge is present or not 312. If a badge or tag is present 314, the system will continuously determine if the badge left the proximity 316. If a user that is logged in leaves the proximity, then they are automatically logged off the application after timeout 318 expires. In addition, the system can transition from the logged in state to the logged out state when a different user logs in by presenting a key 320.

The extension of the present disclosure provides two benefits to the user. The first one is the convenience of fast login and (automatic) logouts. The second benefit is faster operations, which in most cases reduce the time required to log in the system. For example, logging out the current user and logging in again in the conventional scheme would require two mouse clicks and a uid/pwd. In the extension, the same effect is achieved just by presenting the new user's key to the system.

For illustrative purposes, two possible authentication scenarios will be described in relation to FIGS. 3C and D. Referring to FIG. 3C, the user may access the system by presenting the physical key to the reader (step 340) or by providing the user's user id and password (step 342). Once the physical key is presented or user is/password is entered, the system will log-in the user (step 344). The system will then check for an explicit log-off attempt by the user (step 346), and if confirmed, the user will be logged off (step 348). Otherwise, the system will attempt to detect a proximity sensor (step 350). If a proximity sensor is not detected, the system will continually poll the proximity reader 102 to determine if the user has entered the proximity radius 106 (step 352). If in step 352, a proximity tag or badge has been detected, the system will move to step 354.

If it is determined that the user is in the proximity radius (step 354), the system will check for an explicit log-off attempt by the user in step 356, and if confirmed, will log-off the user 358. Otherwise, the system will continue to poll for the presence of a proximity tag for a predetermined amount of time (steps 360 and 362). When the user steps outside the proximity radius 106, the proximity reader 102 will notify the computer system 100, start a timeout period (step 364) and, after the timeout period expires, the user will be logged off (step 364). However, if the user re-enters the proximity radius before the timeout expires (step 364), the system will return to step 356 and the users session will continue.

FIG. 3D illustrates another implementation for user authentication which requires both proximity detection and physical contact. Referring to FIG. 3D, in step 350, the proximity reader 102 detects a user within a proximity radius 106 of the reader 102. A unique identification of the user is sent to the computer system 100 which will now enables the same user to log-on to the system 100 when the user makes physical contact with the system 100 (step 340). When the user makes physical contact, the user is logged into the system (step 344). Once logged in, the system will check for an explicit log-off attempt by the user in step 356, and if confirmed, will log-off the user 358. Otherwise, the system will continue to poll for the presence of a proximity tag for a predetermined amount of time (steps 360 and 362). When the user steps outside the proximity radius 106, the proximity reader 102 will notify the computer system 100, start a timeout period (step 364) and, after the timeout period expires, the user will be logged off (step 364). However, if the user re-enters the proximity radius before the timeout expires (step 364), the system will return to step 356 and the users session will continue.

FIG. 4 shows a multi-authentication module (MAM) embodying the principles of the present disclosure with respect to other modules of a conventional computer system. In this embodiment, the multi-authentication module (MAM) is implemented as a thin layer above the existing mechanisms that can translate the authentication device data into user id/password, or can be used to trigger behavior in the software application (e.g. trigger logoff based on the state of a proximity device).

The multi-authentication module (MAM) can be implemented as a library add-on to the operation system or the application. It could also be fully integrated in applications as a proprietary authentication method. For example, a library add-on is integrated in applications with a thin layer of wrapper code. FIG. 5 shows a high-level class diagram of the library, with the following classes:
CFramework provides the interface to the authentication methods available in the library. It is used to initiate, connect, control, and disconnect the devices, e.g., the proximity reader 102 and physical identification reader 104. In addition, this class provides the interface to communicate data between the application and the library such as user information and states of the authentication devices.
CProximityModule implements the specifics of the proximity device. It provides an interface to execute the actual operations listed in CFramework.
CPhyscialKeyModule implements the specifics of the physical identification reader 104. It provides an interface to execute the actual operations listed in CFramework.

The operation of the authentication framework of the present disclosure is illustrated with several UML (Unified Modeling Language) sequence diagrams. For clearer presentation, some details are omitted. In the diagrams, the client (in this illustration, a dialog named CFrameworkDialog) utilizes the library through a software Application Programming Interface (API) framework. The framework is similarly integrated in an operating system or as a proprietary application authentication method.

FIG. 6 shows the framework initialization sequence. The client calls the Init process, which then creates an instance for each of the modules. Next, the framework connects to each module by calling the Connect method only, or by calling Connect and issuing additional commands (e.g. FeedbackCommand). Finally, the client “logs in”—meaning that if present, the currently logged in user ID is communicated to the framework.

Referring to FIG. 6, the application initializes the multi-authentication module (MAM) in step 601. In step 602, the MAM initializes the physical key module and then initializes the proximity module in step 603. It is to be appreciated that there may be a plurality of physical key and proximity modules depending on the client applications and physical layout of the computing system. In such a scenario, steps 602 and 603 would be repeated until all modules are initialized.

In step 604, the application connects to the initialized MAM. The MAM then connects to the initialized physical key module in step 605, and subsequently, internal communication between the MAM and physical key module occurs in steps 606 and 607. Similarly to step 605, the MAM connects to the initialized proximity module in step 608. As stated above, if there are a plurality of physical key and proximity modules, step 605 and 608 would be repeated until all modules are connected. Additionally, in step 609, the application informs the MAM of user login outside of MAM, for example, when a user logs in using a user id and password.

Once the framework is initiated and connected, the client can activate or deactivate the framework. When the framework is listening, it is referred to as being in poll mode. To deactivate the framework, the client has to abort the listening mode.

FIG. 7 shows the steps taken and the effect of putting the framework in poll mode. In step 701, the client makes a single call (e.g., PollDevice), which triggers a creation of two listening threads, for example, a Proximity thread in step 702 and a PhysicalKey thread in step 703, which put the devices in the correct state, e.g., poll mode.

Once the modules are in poll mode, each device waits for an event to occur, e.g., a user enters the proximity or makes contact with the physical key reader. When the user touches the physical key reader with a key, data from the physical key is read and the following sequence is put in action. First in step 704, the thread “challenges” the data. This is a placeholder for eventual device-level authentication (e.g., fingerprints) against a proprietary server to convert an authentication key embedded in the device to a user id/password. Then in step 705, the thread calls a callback function in the PhysicalKey module that further calls a callback function in the framework, step 706. Finally in step 707, the framework generates an event on the client side and passes through the user data, for example, triggers a login event in the application.

Similarly, the proximity data is processed. In this case, the trigger is a timer that periodically polls the currently present proximity devices. For each proximity device, the data is challenged in step 708 by the Proximity thread. Then in step 709, the thread calls a callback function in the Proximity module that further calls a callback function in the framework, step 710. Finally in step 711, the framework generates an event on the client side and passes through the user data, for example, triggers a login event in the application.

It is to be appreciated that steps 704 through 707 would be repeated for each physical key module present in the system and likewise steps 708 through 711 would be repeated for each proximity module.

Note that it is up to the application to decide what to do based on the data from the framework. In this embodiment, the framework continues to be in poll mode until it is explicitly stopped.

Finally, FIG. 8 is the sequence diagram of the framework abort. In step 801, the client (e.g., application) issues a single Abort command, which stops both threads, the proximity thread in step 802 and the physical key thread in step 803. Additionally, in step 804, the MAM makes an additional call to the physical key module to abort the device poll mode. At the end of the sequence in step 805, the framework generates an event that informs the application that the abort is complete, which can be used by the application to take action (e.g. shutdown the application).

Although one particular implementation of the framework has been described, it illustrates several aspects of multi-modal authentication. The key aspect is the concept of a framework, which provides a simple and device-independent interface to the authentication mechanisms. Other implementations could provide a framework for authentication plug-ins that themselves abstract the devices from the framework. If the plug-in interface is sufficiently comprehensive, any authentication method could easily be added, removed, and turned on or off, without interfering with the framework operation.

One of the most promising applications for the above-described system and method is in the medical domain where computer systems are used in a so-called kiosk mode. In this mode, users use one or several applications of the system on one or more physical computers. These computers are usually distributed throughout the department and the user accesses an application from their current physical location. In addition, new regulations in the healthcare domain require that patient data access (including view) be highly controlled. This requires not only appropriate access rights, but also specific behavior of users and applications in areas where computer screens are accessible to a great number of people including patients and visitors. In these cases, it is of highest importance that users log-out immediately after leaving the proximity of the computer system. Here, the problem is users that do not log out, and also high inconvenience of repetitive log-ins. The present disclosure provides a way to overcome these problems, and even more, provides additional security and potential of further use of the strong authentication in place. For example, the system may perform checks to determine if another user is logged into the system before logging in a new user, and if so, the system will either log-off the previous user or put their session in a standby mode. In this way, there is less of a chance that users may work on a workstation under someone else's identity.

While the invention has been shown and described with reference to certain preferred embodiments thereof, it will be understood by those skilled in the art that various changes in form and detail may be made therein without departing from the spirit and scope of the disclosure as defined by the appended claims.

1. A method for authenticating a user in a computer system including at least one terminal, the method comprising the steps of:
verifying the user physically at the at least one terminal (340, 342);
granting access to the at least one terminal if the user is verified (344);
detecting the user within a predetermined distance of the at least one terminal (360); and
logging off the user when the user is outside the predetermined distance (366).

2. The method as in claim 1, wherein the detecting step includes detecting a user-specific tag having a unique user identification code.

3. The method as in claim 2, wherein the user-specific tag is detected via radio frequency waves.

4. The method as in claim 1, wherein the verifying step comprises entering an id and password associated with the user (342).

5. The method as in claim 1, wherein the verifying step comprises the step of reading a unique user identification code from a physical identification device (340).

6. The method as in claim 5, wherein the physical identification device (104) is a biometric identification device, a contact reader, or a smartcard reader.

7. The method as in claim 1, further comprising the step of logging in the user if the user is detected within the predetermined distance with a predetermined period of time after being logged off (364).

8. The method as in claim 1, wherein the granting access step further comprises the steps of:
determining if at least one other user is logged in to the at least one terminal; and
logging off the at least one other user.

9. The method as in claim 1, wherein the verifying step includes detecting the user within the predetermined distance before granting access to the at least one terminal (350).

10. A system for authenticating a user in a computer system including at least one terminal, the system comprising:
a proximity identification reader (102) for detecting a user within a predetermined distance of the at least one terminal (100);
a physical identification reader (104) for verifying the user physically at the at least one terminal (100); and
a processor 202 for granting access to the at least one terminal if the detected user is verified.

11. The system as in claim 10, wherein the proximity identification reader (102) detects a user-specific tag having a unique user identification code.

12. The system as in claim 11, wherein the user-specific tag is detected wirelessly.

13. The system as in claim 10, wherein the physical identification device (104) is a biometric identification device, a contact reader, or a smartcard reader.

14. The system as in claim 10, wherein the physical identification device (104) verifies the user by reading a physical key.

15. The system as in claim 14, wherein the physical key is a secure token or a smartcard.

16. The system as in claim 11, wherein the physical identification device (104) verifies the user by reading a physical key, and the user-specific tag and physical key are an integrated device.

17. The system as in claim 16, wherein the proximity identification reader (102) and physical identification reader (104) are an integrated device.

18. The system as in claim 10, wherein the processor logs off the user if the user is no longer detected.

19. The system as in claim 10, wherein the physical identification reader is an input device for entering a user id and password.

20. A program storage device readable by a machine, tangibly embodying a program of instructions executable by the machine to perform method steps for authenticating a user, the method steps comprising:
verifying the user physically at the at least one terminal;
granting access to the at least one terminal if the user is verified;
detecting the user within a predetermined distance of the at least one terminal; and
logging off the user when the user is outside the predetermined distance.
